(19) United States
(12) Patent Application Publication
(10) Pub. No.: US 2015/0067537 A1
(43) Pub. Date: Mar. 5, 2015

(54) SOCIAL NETWORK SERVICE-BASED CONTENT CREATING SYSTEM AND METHOD

(71) Applicant: ELECTRONICS AND TELECOMMUNICATIONS RESEARCH INSTITUTE, Daejeon (KR)

(72) Inventors: Ki Suk LEE, Daejeon (KR); Hyun Bin KIM, Daejeon (KR); Seong Won RYU, Daejeon (KR); Su Ran PARK, Daejeon (KR); Ki Hong KIM, Daejeon (KR); Gil Haeng LEE, Seoul (KR)

(73) Assignee: ELECTRONICS AND TELECOMMUNICATIONS RESEARCH INSTITUTE, Daejeon (KR)

(21) Appl. No.: 14/268,631

(22) Filed: May 2, 2014

(30) Foreign Application Priority Data
Sep. 4, 2013 (KR) 10-2013-0106011

(51) Int. Cl. H04L 29/06; G06F 17/30; G06F 3/0484

(52) U.S. Cl. CPC H04L 65/403; G06F 3/0484; G06F 17/30091; G06F 17/30289
USPC 715/753

(57) ABSTRACT

Provided are an SNS-based content creating system and method. The SNS-based content creating system includes a terminal configured to share a content creation information or a content correction information with the other terminal through the SNS and a visualization object managing server configured to manage the database, wherein the terminal comprises a user input unit configured to receive text information, a text processor configured to recommend a visualization candidate material for the text information by using a database, a visualization processor configured to create or correct content, based on selection information about the recommended visualization candidate material and a network processor configured to transmit the content to other terminal.

### CROSS-REFERENCE TO RELATED APPLICATIONS

This application claims priority under 35 U.S.C. §119 to Korean Patent Application No. 10-2013-0106011, filed on Sep. 4, 2013, the disclosure of which is incorporated herein by reference in its entirety.

### TECHNICAL FIELD

The present invention relates to a social network service (SNS)-based content creating system and method.

### BACKGROUND

In the related art, when collaboration is made for creating content, main agents such as a planner, an author, a designer, a developer, etc. perform separate works by using different tools, and main creation agents exchange their opinions through a document or schematic drawing, thereby creating content.

However, in a related art content creation collaboration method that exchanges opinions between main creation agents through a document or schematic drawing, it is difficult to clearly exchange opinions between main creation agents, and main creation agents have a low degree of understanding of separate works in collaboration. For this reason, a degree of satisfaction of a created content result is low.

Moreover, since a degree of satisfaction of a created content result is low, rework is frequently required in creating content, and for this reason, a work of main creation agent is consumptive and unproductive.

Methods, which solve the problems and allow collaboration on content creation to be more effectively made, are being proposed, but a degree of improvement is slight due to a restriction of technology/time/space. Therefore, under a current technical level, an intermediate content result is more frequently checked depending on a progress of content creation work.

Recently, due to the advent of globalization era, advanced countries perform plan work, and less-developed countries perform design work. Therefore, a trend toward division of work is more increasing in content creation, and thus, it is increasingly required to develop technology that enables more clear and intuitive communication to be performed between a plurality of main creation agents.

### SUMMARY

Accordingly, the present invention provides an SNS-based content creating system and method which, when a plurality of users collaboratively create content, create the content by inputting a text material based on an SNS or inputting a material directly acquired by a user, thereby enabling clear communication having high instantaneity to be performed between the users.

In one general aspect, an SNS-based content creating system includes: a terminal configured to share a content creation information or a content correction information with the other terminal through the SNS and a visualization object managing server configured to manage the database, wherein the terminal comprises a user input unit configured to receive text information, a text processor configured to recommend a visualization candidate material for the text information by using a database, a visualization processor configured to create or correct content, based on selection information about the recommended visualization candidate material and a network processor configured to transmit the content to other terminal.

In another general aspect, an SNS-based content creating method includes: acquiring input data; determining whether the acquired input data is text information; when the input data is the text information, analyzing the text information to calculate a visualization candidate material for the text information; recommending the calculated visualization candidate material, and creating or correcting content, based on selection information for the recommended visualization candidate material; and sharing creation or correction information of the content through the SNS.

Other features and aspects will be apparent from the following detailed description, the drawings, and the claims.

### BRIEF DESCRIPTION OF THE DRAWINGS

FIG. 1 is a block diagram illustrating an SNS-based content creating system according to an embodiment of the present invention.

FIG. 2 is a conceptual diagram illustrating a nodalization structure of the SNS-based content creating system according to an embodiment of the present invention and different text information inputs of users for the same node.

FIG. 3 is a flowchart illustrating an SNS-based content creating method according to an embodiment of the present invention.

FIG. 4 is an exemplary diagram of a computer system implementing an embodiment of the present invention.

### DETAILED DESCRIPTION OF EMBODIMENTS

Hereinafter, embodiments of an SNS-based content creating system and method according to the present invention will be described in detail with reference to the accompanying drawings. Moreover, detailed descriptions related to well-known functions or configurations will be ruled out in order not to unnecessarily obscure subject matters of the present invention.

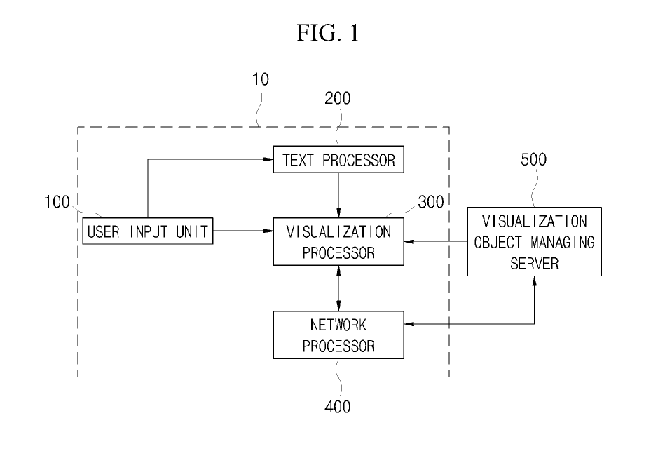

FIG. 1 is a block diagram illustrating an SNS-based content creating system according to an embodiment of the present invention.

The SNS-based content creating system according to an embodiment of the present invention includes a terminal 10 which shares a content creation information or a content correction information with the other terminal through the SNS and a visualization object managing server 500 configured to manage the database. And the terminal 10 comprises a user input unit 100 that receives text information, a text processor 200 that recommends a visualization candidate material for the text information by using a database, a visualization processor 300 that creates or corrects content based on selection information about the recommended visualization candidate material, and a network processor 400 that transmits the content to the other terminal.

The user input unit 100 includes at least one of a text input interface, a graphic user interface (GUI), an image input interface, and a sound input interface.

The user input unit 100 receives, through the at least one interface, at least one of the text information, image information and sound information (which are pre-acquired at a place of a user), and the recommended visualization candidate material.

That is, the user input unit 100 may receive, as input information, at least one of the text information, and image information and sound information which are pre-acquired under an ambient environment of the place at which the user is located, and thus expand the kind of a subject matter of creation and correction of content. Accordingly, it is possible to collect a content material having high realism and instantaneity.

In this case, the image information is image information or depth image information, which is acquired by a camera included in the terminal 10. The user input unit 100 receives, through the GUI, selection information about a visualization candidate material recommended by the text processor 200.

Moreover, the user input unit 100 receives the user's voice through the sound input interface, and converts the received user voice into a text, thereby receiving the converted user voice through the text input interface.

Moreover, the user input 100 receives the user voice through the sound input interface, and transmits the received user voice to the other terminal through the network processor 400. The other terminal receives the transmitted user voice, thereby enabling the user and a user of the other terminal to perform mutual discussion through a voice.

The text processor 200 performs natural language processing of the received text information, and recommends the visualization candidate material on the basis of the natural-language-processed text information.

That is, the text processor 200 may analyze the received text information through the natural language processing, recommend visualization candidate materials such as an image, a two-dimensional (2D) model, and a three-dimensional (3D) model on the basis of the text information, and recommend a sound material on the basis of the text information.

In this case, the text processor 200 may search for and recommend the visualization candidate material by using data stored in the database, or search for and recommend the visualization candidate material among the data stored in the database.

Moreover, the text processor 200 calculates a suitability of object visualization between the data stored in the database and the natural-language-processed text information, and recommends the visualization candidate material in consideration of the calculated suitability of object visualization.

In this case, the text processor 200 calculates the suitability of object visualization between the natural-language-processed text information and the database, as expressed in Equation (1) based on the number of selections of the visualization candidate material, the number of recommendations of the visualization candidate material, and a correlation between input text information and pre-searched text information.

suitability of object visualization=A/B×T1+R×T2 (1)

where A denotes the number of selections of the visualization candidate material, B denotes the number of recommendations of the visualization candidate material, T1 denotes a first weight value, R denotes a correlation between input text information and pre-searched text information, and T2 denotes a second weight value.

Here, the number of recommendations of the visualization candidate material denotes the number of times the visualization candidate material is recommended for the text information, and the number of selections of the visualization candidate material denotes the number of times the user selects the visualization candidate material for the recommended visualization candidate material.

Moreover, the text processor 200 recommends the visualization candidate material for the text information in consideration of the calculated suitability of object visualization.

Moreover, in recommending the visualization candidate material on the basis of the natural-language-processed text information, the text processor 200 recommends the visualization candidate material having a high degree of similar use by using concatenation information of words composing the text information.

Moreover, the database stores the visualization candidate material. The visualization candidate material is hierarchically analyzed, and stored in the database.

When searching the database for recommending a visualization candidate material having a high suitability of object visualization with the text information, the text processor 200 limits a search range for a visualization candidate material having a high association with the text information, and enables hierarchical selection to be performed.

The visualization processor 300 performs rendering of an object selected for at least one of the recommended visualization candidate material and the image information to create or correct the content.

That is, the visualization processor 300 performs rendering based on the visualization candidate material (selected by the text processor 200) and the image information acquired through the user input unit 100, thereby creating or correcting the content.

In this case, the visualization processor 300 may create or correct the content on the basis of the sound information received by the user input unit 100, and when a sound is selected from among materials that are proposed by text processor 200 for the text information, the visualization processor 300 may create or correct the content by using the sound.

Moreover, when the content is created or corrected based on the text information, the visualization processor 300 nodalizes the content for each object.

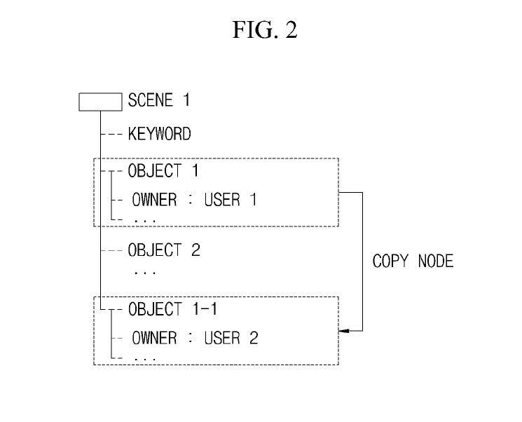

FIG. 2 is a conceptual diagram illustrating a nodalization structure of the SNS-based content creating system according to an embodiment of the present invention and different text information inputs of users for the same node.

In order to visualize a scene description, the visualization processor 300 manages all visualized objects in a node type, and the node-type management enables an object composing the content to be easily added, corrected, and deleted.

According to FIG. 2 and an embodiment of the present invention, texts describing a scene for a scene “SCENE 1” are divided by object and nodalized, and a plurality of the objects are illustrated as OBJECT 1 and OBJECT 2.

In this case, the visualization processor 300 generates a node that includes user information, creation information of the content, or correction information of the content.

That is, when two users input different texts based on different opinions for the object “OBJECT 1”, the visualization processor 300 generates a copy node including pieces of user information “USER 1” and “USER 2” for the object “OBJECT 1”.

Therefore, a user other than the two users may selectively adopt the creation or correction of the content based on the different opinions of the two users.

In this case, an object visualization candidate material based on the creation or correction of the content is visualized and provided as an icon, and thus is selected through the GUI.

Moreover, selection information of an object “OBJECT 1” or object “OBJECT 1-1” of the user other than the two users is recorded in the visualization object managing server 500 along with text information of the object “OBJECT 1” or the object “OBJECT 1-1”, and is stored in the database.

The network processor 400 enables the content to be shared over a wired/wireless network, and shares, through the SNS, the creation information or correction information of the content of each of the terminal 10 and the other terminal.

In this case, the network processor 400 selectively updates the creation information or correction information of the content in order for a plurality of users to simultaneously create or correct the content.

That is, among a plurality of the nodes, only a node in which a change occurs due to creation or correction work is separately updated, and thus, a network can be smoothly used, thereby preventing a rendering speed from being lowered.

The visualization object managing server 500 stores the text information and the recommendation and selection information of the visualization candidate material to manage the database.

That is, the visualization object managing server 500 manages data associated with the text information. In detail, the visualization object managing server 500 structurizes and registers the data associated with the text information, thereby facilitating content creation or correction work based on the input information.

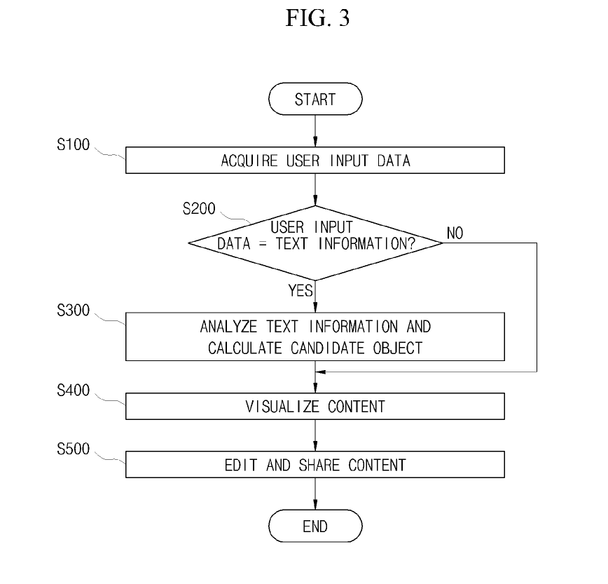

FIG. 3 is a flowchart illustrating an SNS-based content creating method according to an embodiment of the present invention.

The SNS-based content creating method according to an embodiment of the present invention includes: operation S100 of acquiring user input data; operation S200 of determining whether the acquired input data is text information; operation S300 of, when the input data is the text information, analyzing the text information to calculate a visualization candidate material for the text information; operation S400 of recommending the calculated visualization candidate material, and creating or correcting content on the basis of selection information for the recommended visualization candidate material to visualize the content; and operation S500 of sharing the creation or correction information of the content through the SNS.

Operation S100 of acquiring the user input data receives at least one of the text information, image information and sound information (which are pre-acquired at a place of a user), and the recommended visualization candidate material through at least one of a text input interface, a GUI, an image input interface, and a sound input interface.

That is, the user input data is text information input by the user, or is image information or sound information which is pre-acquired at a place at which the user is located. The image information is image information or depth image information, which is acquired by the camera equipped in the terminal 10.

Moreover, the SNS-based content creating method according to an embodiment of the present invention further includes an operation that stores the text information, the calculated visualization candidate material, the recommended visualization candidate material, and the selection information in a database.

The operation, which stores the text information, the calculated visualization candidate material, the recommended visualization candidate material, and the selection information in the database, structurizes data associated with the text information to store the structurized data in the database.

When the acquired user input data is at least one of the image information and the sound information, operation S400 of creating or correcting the content calculates an object for the image information or the sound information, and creates or corrects the content on the basis of the calculated object.

That is, content is created and corrected based on image information or sound information acquired from a place at which the user is located, and thus, the kind of a basic material for creating and correcting the content can be expanded, and content having high realism and instantaneity can be created or corrected.

Moreover, operation S100 of acquiring the user input data receives a user voice, converts the received user voice into text information, thereby receiving the converted text information corresponding to the user voice through the text input interface.

In another embodiment, operation S100 of acquiring the user input data receives the user voice through the sound input interface, and transmits the received user voice to the other terminal. The other terminal receives the transmitted user voice, thereby enabling the user and a user of the other terminal to exchange opinions through a voice call.

Operation S300 of analyzing the text information to calculate the visualization candidate material for the text information performs natural language processing of the text information, and calculates the visualization candidate material on the basis of the natural-language-processed text information. Also, operation S300 of calculating the visualization candidate material calculates the visualization candidate material in consideration of a suitability of object visualization which is calculated based on the number of selections of the visualization candidate material, the number of recommendations of the visualization candidate material, and a correlation between input text information and pre-searched text information.

In this case, operation S300 of analyzing the text information to calculate the visualization candidate material calculates the suitability of object visualization as expressed in Equation (1).

That is, the suitability of object visualization increases as the number of selections of the visualization candidate material increases with respect to the number of recommendations of the visualization candidate material for the text information and the correlation between input text information and the pre-searched text information becomes higher.

Moreover, operation S400 of creating or correcting the content performs rendering of an object selected for at least one of the recommended visualization candidate material and the image information.

That is, an object composing the content is at least one of a visualization candidate material, having a high suitability of object visualization with the received text information, and the image information pre-acquired by the user. The object is visualized by performing rendering of the object.

Moreover, operation S400 of creating or correcting the content nodalizes the content for each object. The node may include user information, the creation information of the content, or the correction information of the content.

Therefore, a plurality of users participating in creation or correction work of the content may create or correct the content for each node of the object composing the content. When the node includes a plurality of corrections, the users may select one of the plurality of corrections.

That is, different opinions of the plurality of users participating in the content creation are shared, and information about the creation or correction of the content is selectively applied, thereby increasing an effect of collaboration.

Moreover, operation S500 of sharing the creation or correction information of the content through the SNS performs updating of a node including the content correction information to update the content, thereby sharing the updated content through the SNS.

In detail, in a case where the content correction information is input to a specific node, when updating of all nodes by object composing the content is performed, a rendering speed is reduced by reflecting the content correction information to perform rendering of the content. To solve such a problem, by performing updating of only a node including the correction information, a network can be more effectively used, and the rendering speed can be prevented from being reduced due to the correction information.

As described above, in creating or correcting content which is collaboratively created by a plurality of users, the SNS-based content creating system and method visualize user input information, and share the visualized user input information, thereby obtaining objectified content that is understandable by all the users.

Moreover, according to the present invention, content is created and corrected based on a material acquired from a place at which a user is located, and thus, the kind of a subject matter based on creation and correction of content can be expanded, and a content material having high realism and instantaneity can be collected.

Moreover, according to the present invention, information for creation or correction of content can be easily input by searching for and recommending a visualization candidate material for received text information by using a database, and by storing history information about reception of text information, search and recommendation of a visualization candidate material, and selection of a visualization material, a visualization candidate material having high suitability with later-input text information can be searched and recommended. Accordingly, a suitability and reliability of search and recommendation of a visualization candidate material can be enhanced.

Moreover, according to the present invention, by creating visualized content based on a text input, a problem can be solved in which users associate different pieces of content depending on subjective determinations although the same material is proposed, in a related art collaboration of content creation, and when a user has an inspiration of content creation without time and space restrictions, an environment for creating content is immediately provided. Also, even when a plurality of users are respectively located at remote places, smooth communication between the users can be performed, and a collaboration of content creation suitable for each user's intention can be made.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

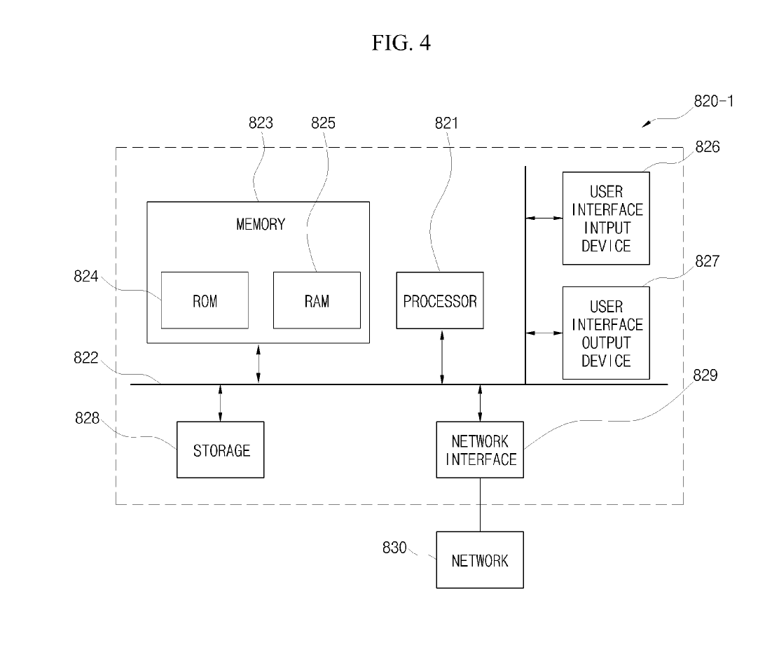

An embodiment of the present invention may be implemented in a computer system, e.g., as a computer readable medium. As shown in in FIG. 4, a computer system 820-1 may include one or more of a processor 821, a memory 823, a user input device 826, a user output device 827, and a storage 828, each of which communicates through a bus 822. The computer system 820-1 may also include a network interface 829 that is coupled to a network. The processor 821 may be a central processing unit (CPU) or a semiconductor device that executes processing instructions stored in the memory 823 and/or the storage 828. The memory 823 and the storage 828 may include various forms of volatile or non-volatile storage media. For example, the memory may include a read-only memory (ROM) 824 and a random access memory (RAM) 825.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

What is claimed is:

1. A social network service (SNS)-based content creating system comprising:
a terminal configured to share a content creation information or a content correction information with the other terminal through the SNS; and
a visualization object managing server configured to manage the database,
wherein the terminal comprises,
a user input unit configured to receive text information;
a text processor configured to recommend a visualization candidate material for the text information by using a database;
a visualization processor configured to create or correct content, based on selection information about the recommended visualization candidate material; and
a network processor configured to transmit the content to other terminal.

2. The SNS-based content creating system of claim 1, wherein the visualization object managing server stores the text information, the recommended visualization candidate material, and the selection information to manage the database.

3. The SNS-based content creating system of claim 1, wherein,
the user input unit comprises at least one of a text input interface, a graphic user interface (GUI), an image input interface, and a sound input interface, and
the user input unit receives, through the at least one interface, at least one of the text information, image information and sound information which are pre-acquired at a place of a user, and the recommended visualization candidate material.

4. The SNS-based content creating system of claim 3, wherein the user input unit receives a user voice, and converts the received user voice into a text to receive the converted user voice through the text input interface.

5. The SNS-based content creating system of claim 1, wherein the text processor performs natural language processing of the received text information, and recommends the visualization candidate material, based on the natural-language-processed text information.

6. The SNS-based content creating system of claim 5, wherein the text processor calculates a suitability of object visualization between the natural-language-processed text information and the database, based on number of selections of the visualization candidate material, number of recommendations of the visualization candidate material, and a correlation between input text information and pre-searched text information, and recommends the visualization candidate material in consideration of the calculated suitability of object visualization.

7. The SNS-based content creating system of claim 3, wherein the visualization processor performs rendering of an object selected for at least one of the recommended visualization candidate material and the image information, and creates or corrects the content, based on the rendered object.

8. The SNS-based content creating system of claim 7, wherein the visualization processor nodalizes the content, which is created based on the text information, for each object.

9. The SNS-based content creating system of claim 8, wherein the visualization processor generates a node that includes user information, creation information of the content, or correction information of the content.

10. The SNS-based content creating system of claim 9, wherein the network processor performs updating of a node including the correction information to update the content.

11. A social network service (SNS)-based content creating method comprising:
acquiring input data;
determining whether the acquired input data is text information;
when the input data is the text information, analyzing the text information to calculate a visualization candidate material for the text information;
recommending the calculated visualization candidate material, and creating or correcting content, based on selection information for the recommended visualization candidate material; and
sharing creation or correction information of the content through the SNS.

12. The SNS-based content creating system of claim 11, wherein the acquiring of input data comprises receiving at least one of the text information, image information and sound information which are pre-acquired at a place of a user, and the recommended visualization candidate material through at least one of a text input interface, a graphic user interface (GUI), an image input interface, and a sound input interface.

13. The SNS-based content creating system of claim 12, further comprising storing the text information, the calculated visualization candidate material, the recommended visualization candidate material, and the selection information in a database.

14. The SNS-based content creating system of claim 12, wherein the creating or correcting of content comprises, when the acquired input data is at least one of the image information and the sound information, calculating an object for the image information or the sound information, and creating or correcting the content, based on the calculated object.

15. The SNS-based content creating system of claim 12, wherein the acquiring of input data comprises receiving a user voice, converting the received user voice into text information, and receiving the converted text information corresponding to the user voice through the text input interface.

16. The SNS-based content creating system of claim 11, wherein the analyzing of the text information to calculate a visualization candidate material comprises performing natural language processing of the text information, and calculating the visualization candidate material, based on the natural-language-processed text information.

17. The SNS-based content creating system of claim 16, wherein the analyzing of the text information to calculate a visualization candidate material comprises calculating the visualization candidate material in consideration of a suitability of object visualization which is calculated based on number of selections of the visualization candidate material, number of recommendations of the visualization candidate material, and a correlation between input text information and pre-searched text information.

18. The SNS-based content creating system of claim 12, wherein the creating or correcting of content comprises performing rendering of an object selected for at least one of the recommended visualization candidate material and the image information.

19. The SNS-based content creating system of claim 18, wherein the creating or correcting of content comprises nodalizing the content for each object, the nodalized node including user information, the creation information of the content, or the correction information of the content.

20. The SNS-based content creating system of claim 19, wherein the sharing of creation or correction information comprises performing updating of a node including the content correction information to update the content, and sharing the updated content through the SNS.
